(19) United States
(12) Patent Application Publication
(10) Pub. No.: US 2020/0399956 A1
(43) Pub. Date: Dec. 24, 2020

(54) CONNECTION HEAD OF AN APPARATUS FOR ACTUATING ROLL-UP AWNINGS OR BLACKOUT CLOSURES

(71) Applicant: CHERUBINI S.P.A., Bedizzole (Brescia) (IT)

(72) Inventors: Lionello CHERUBINI, Bedizzole (Brescia) (IT); Matteo GERLINZANI, Bedizzole (Brescia) (IT)

(21) Appl. No.: 16/969,479

(22) PCT Filed: Feb. 25, 2019
(86) PCT No.: PCT/IB2019/051492

§ 371 Date: Aug. 12, 2020

(30) Foreign Application Priority Data
Feb. 26, 2018 (IT) 102018000003023

(51) Int. Cl. E06B 9/42; E06B 9/70

(52) U.S. Cl. CPC E06B 9/42; E06B 9/70

(57) ABSTRACT

A connection head includes a first body indentation to accommodate a support recess with a second fixed support, a second body indentation flanked by the first body indentation, the first and second body indentations being divided by a body edge, and an element applicable to the side body surface, having an indentation. When the element is applied, the indentation is connected to the second body indentation of the main body to accommodate at least one support bracket of a first fixed support.

The present invention is in the field of devices for the electrical actuation of roll-up awnings or blackout closures. In particular, the object of the present invention is a connection head between an electric motor and a fixed support for an actuation apparatus.

Such devices, now widely used, comprise a tubular electric motor, a connection head and a fixed support;

the connection head is engaged on one side with the electric motor, while on the other side it is engaged with the fixed support, fixed, as the case may be, to a support wall, for example consisting of the side of a box wherein the roll-up awning is rolled, or the flange of the support frame of an awning. An example of embodiment of a connection head is illustrated in the document DE202007001705 in the name of the Applicant.

Given the enormous popularity of these devices, there are different types of electric motors, support heads and fixed supports, so as to meet at times very different needs. However, it is often very difficult to replace an electric motor with another of a different type, especially if they come from different manufacturers, because it would be necessary to also replace the fixed support, removing it from the support wall to mount thereon one suitable for the head of the new motor.

The object of the present invention is to create a connection head capable of overcoming the aforesaid drawbacks and, at the same time, meeting the needs of the sector.

Such object is achieved by a connection head according to claim 1. The dependent claims describe further advantageous embodiments of the invention.

The features and advantages of the connection head according to the present invention will be apparent from the description given below, provided by way of non-limiting example, in accordance with the accompanying figures, wherein:

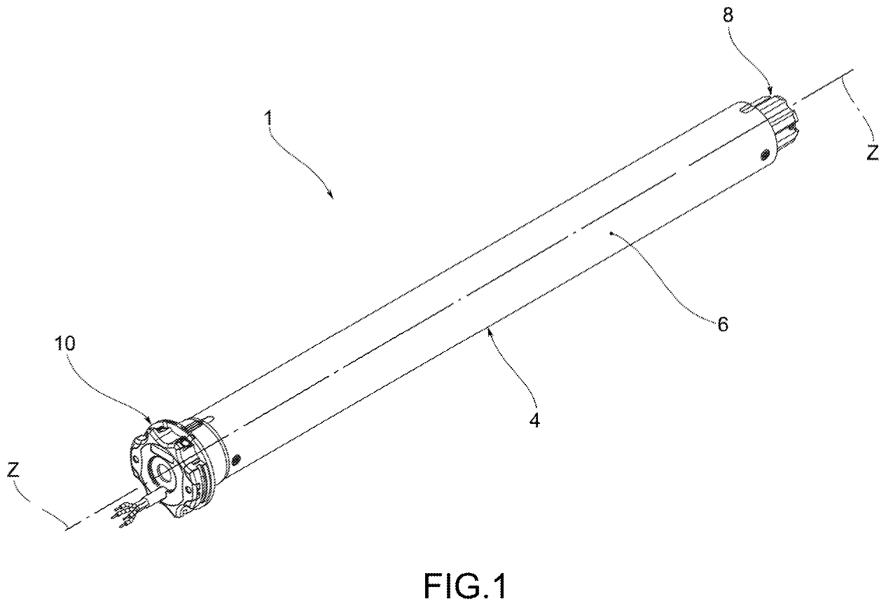

FIG. 1 shows a motor group comprising a connection head according to an embodiment of the present invention;

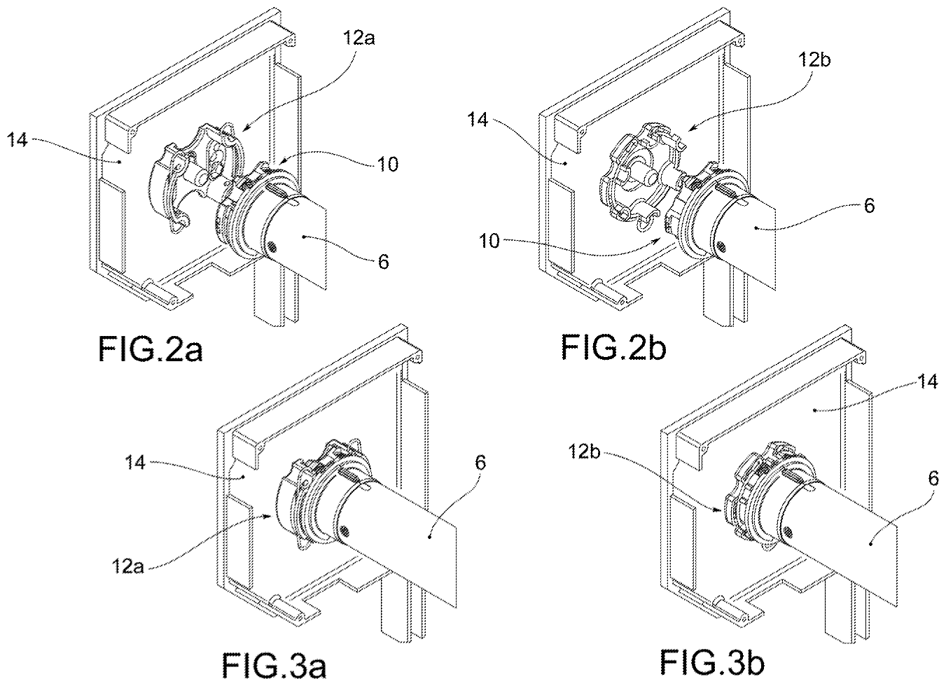

FIGS. 2a, 3a and 2b, 3b show fixed supports of different types coupled to the respective connection heads, according to an embodiment of the present invention;

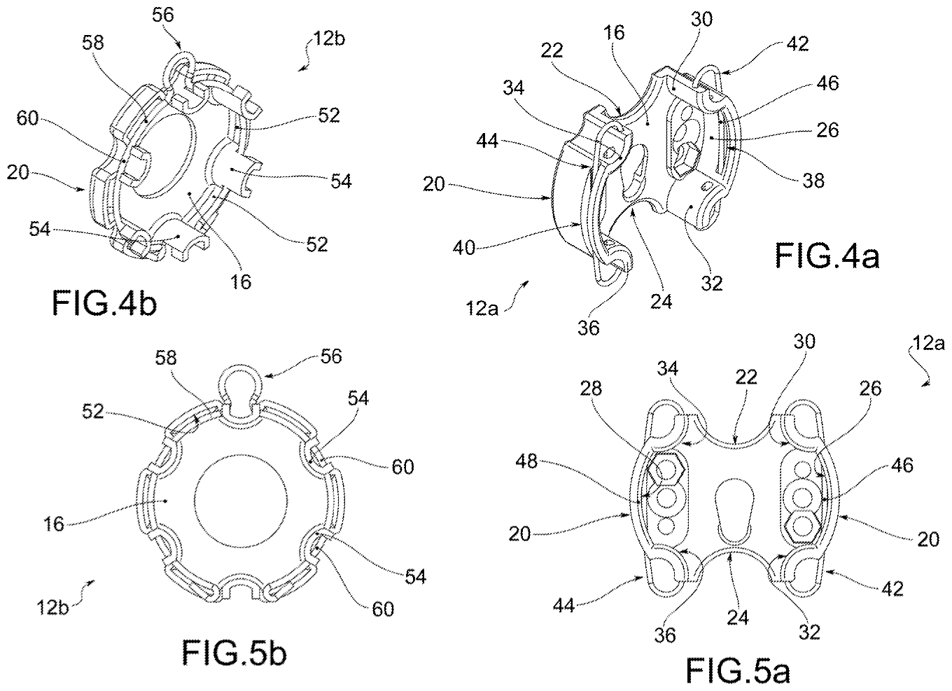

FIGS. 4a, 5a and 4b, 5b illustrate two different types of fixed supports;

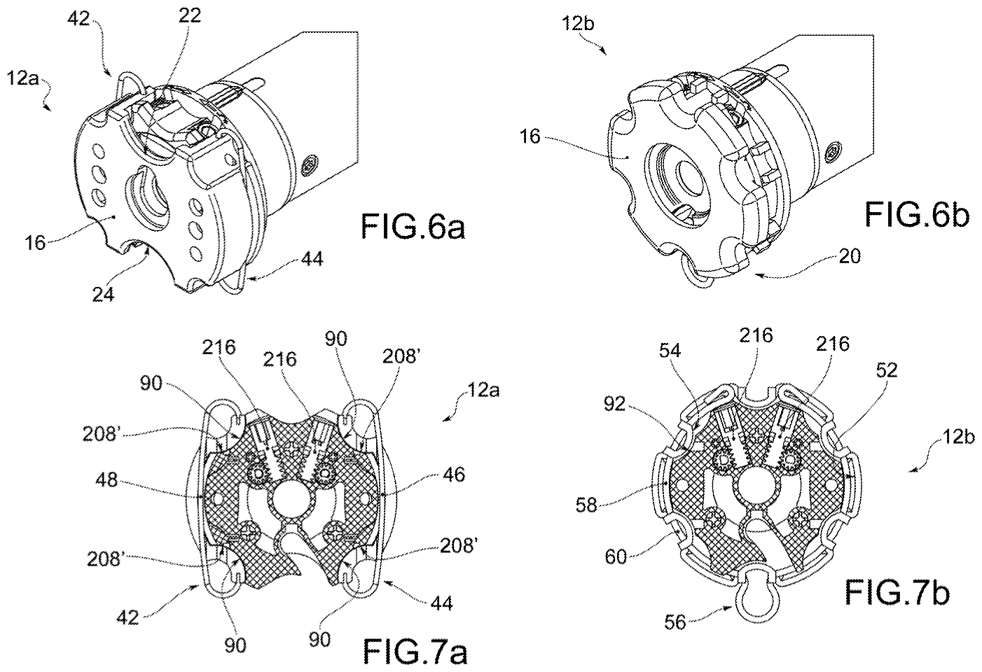

FIGS. 6a, 7a and 6b, 7b show two different fixed supports coupled to the respective heads, respectively in axonometric view and in cross-section;

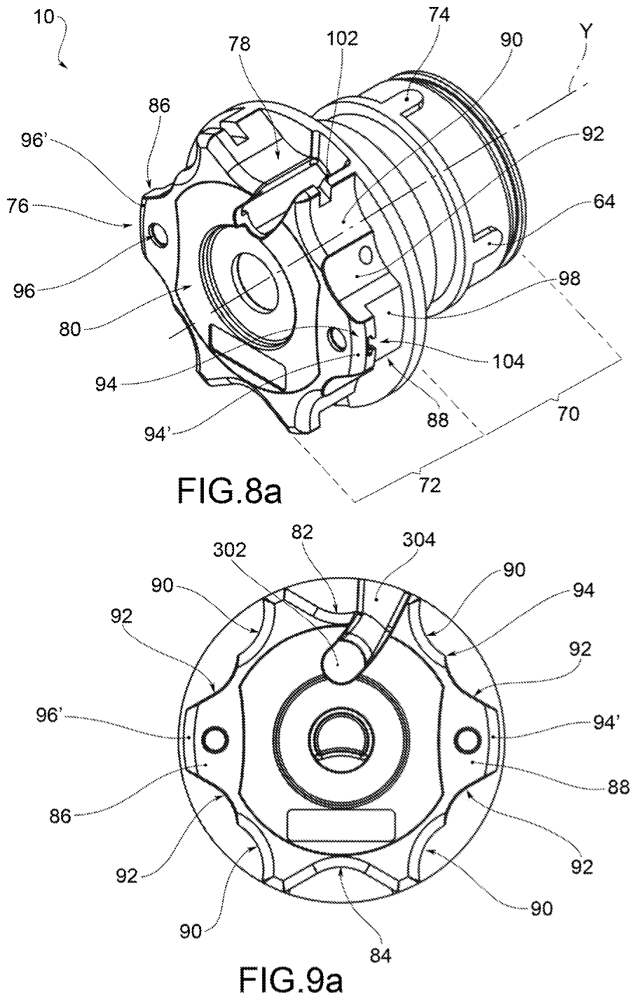

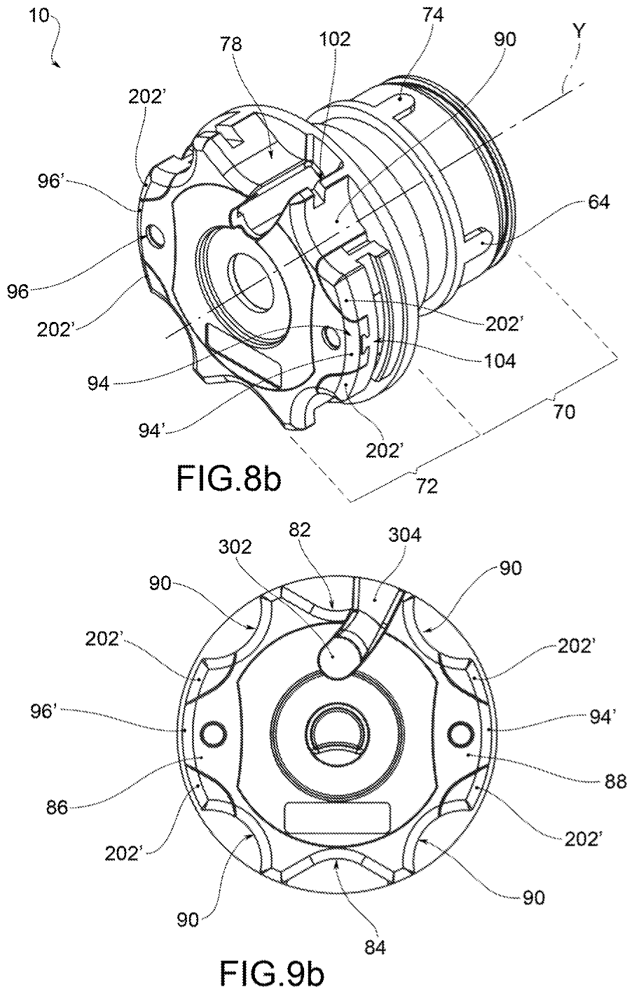

FIGS. 8a, 9a and 8b, 9b depict the head according to the present invention, in two configurations;

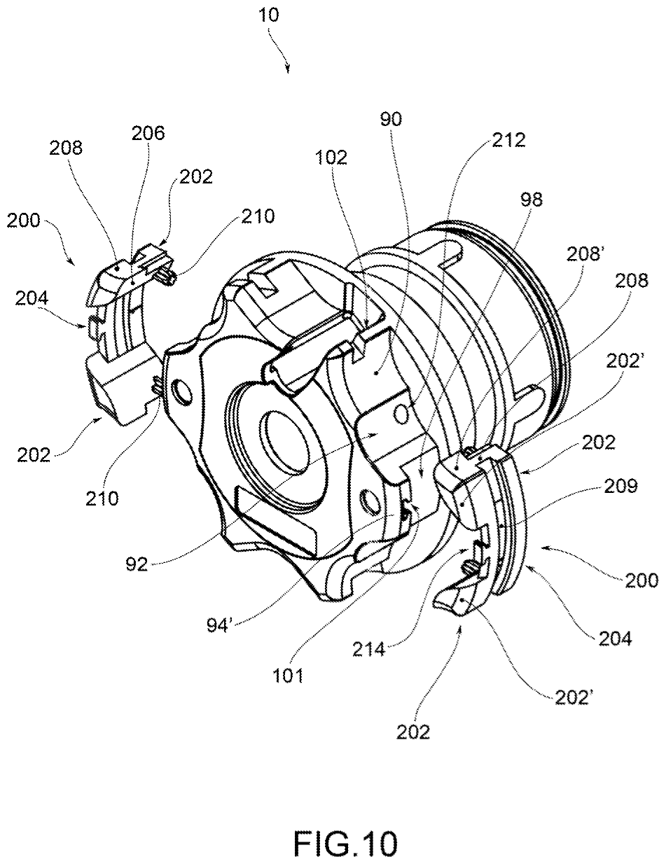

FIG. 10 represents the head according to the invention with separate auxiliary elements;

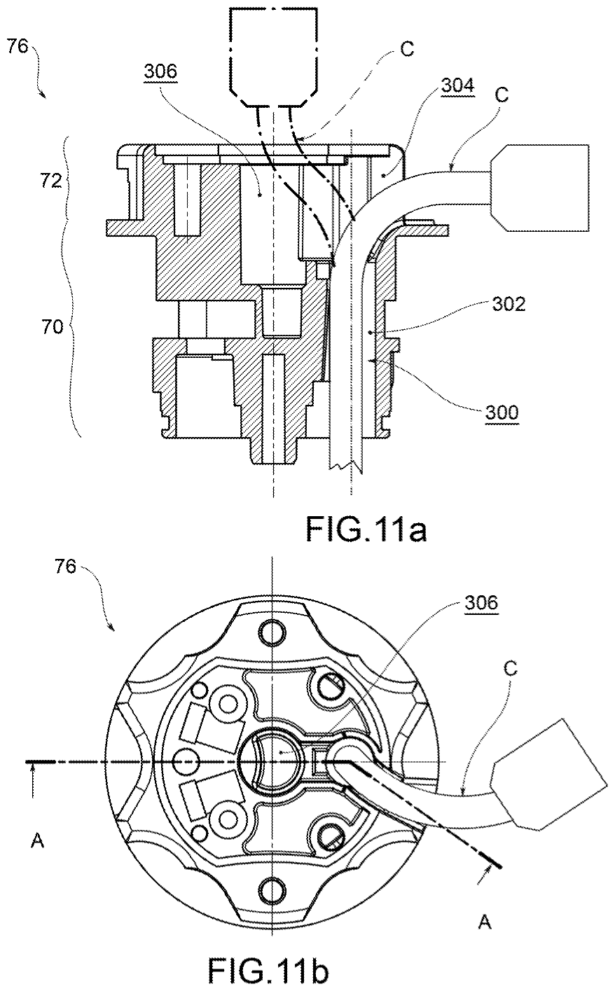

FIG. 11a illustrates a longitudinal view in cross-section of the head, together with a power cord in two positions; and

FIG. 11b illustrates a plan view of the head of FIG. 11a.

With reference to FIG. 1, a motor group is collectively indicated at 1, comprising a tubular casing 6, usually cylindrical, an electric motor, contained in the casing 6, and a kinematic mechanism, comprising a planetary gearbox, mainly contained in the casing 6, connected to the electric motor and provided with an output shaft 8 for the mechanical connection to the roll-up awning, generally by means of an adapter.

Examples of such motor groups are illustrated in the International Application WO-A1-2017/221087 and in the Italian patent application for invention IT102016000100776, in the name of the Applicant.

According to FIGS. 2a and 3a, 2b and 3b, an actuation system according to an embodiment of the present invention comprises the electric motor, a connection head 10 and a fixed support 12a, 12b, intended to be fixed, for example by means of screws, to a fixed support wall 14, for example consisting of the side of a box wherein the roll-up awning is rolled or of a flange of a support frame of the awning.

For example, according to a first embodiment (FIGS. 4a, 5a, 6a, 7a), a first fixed support 12a comprises a support base 16, generally flat, intended to come into contact with the support wall 14 and to be fixed thereto, e.g. by screws. For this purpose, the support base 16 is usually penetrated by a plurality of through holes.

The support 12a further comprises a side support wall 20 arranged peripherally relative to the support base 16 and protrudes axially therefrom, so as to make a sort of cover.

The support base 16 is shaped along the outer periphery and has a pair of bottom brackets 22, 24, concave and arched, arranged diametrically opposite.

Preferably, the side support wall 20 is interrupted (or completely absent) at the two bottom brackets 22, 24, so as to form a side support wall 20 divided into two parts.

Each part of the side wall 20 has internally a support protuberance 26, 28, concave and arched; the two support protuberances 26, 28 are diametrically opposite, arranged orthogonally to the bottom recesses 22, 24.

Each part of the side wall 20 also has two support brackets 30, 32; 34, 36, convex and arched, arranged at the respective ends of the support protuberances 26, 28.

The same shape is repeated on the outside of the support base 16.

The support 12a further comprises a pair of slots 38, 40, each passing through the thickness of each part of the side support wall 20, and a pair of elastic retainers 42, 44, fixed to the side support wall 20, so that a deformable section 46, 48 thereof penetrates the respective slot 38, 40, protruding inside the support 12a, to snap-engage with the connection head 10.

According to a second embodiment (FIGS. 4b, 5b, 6b, 7b), a second fixed support 12b comprises the support base 16 and the side support wall 20.

The side wall 20 is made up internally of a circumferential succession of support brackets 52, concave and arched, and support recesses 54, convex and arched, alternating with the support brackets 52, preferably equidistant angularly and preferably having the same angular dimension.

The side support wall 20 protrudes from the support base 16 and maintains externally the shape of the inner contour.

In addition, the axial height of the support recess is greater than the axial height of the support brackets 52. On the axial extension of said support recesses 54 there is thus positioned an elastic retainer 56, for the entire circumference of the support 12b, to snap-engage with the connection head 10.

In particular, said elastic retainer 56 has first deformable sections 58 that extend to the support brackets 52 and second sections 60 that pass externally to the support recesses 54.

The first sections 58 are intended to snap-engage with the connection head 10.

The connection head 10 is suitable to engage with shape-coupling with the second support 12b and, through the application of elements 200, described hereinafter, with the first support 12a.

The connection head 10 has a head axis Y and comprises a motor connection portion 70 and, flanked axially thereto, a support connection portion 72 (FIG. 8a).

The motor connection portion 70 is intended to be connected to the casing 6 of the motor device and comprises, for example, at least one key 74 for the anti-rotation engagement with said casing.

The support connection portion 72 comprises a main body 76 shaped peripherally so as to be insertable into each support 12a, 12b and to shape-couple with the respective inner surface of the side support wall 20.

In particular, the main body 76 has a side body surface 78, with circumferential extension, and a body front surface 80 lying on an imaginary plane orthogonal to the head axis Y.

Preferably, the side body surface 78 has a pair of body brackets 82, 84, concave and arched, diametrically opposite, and a pair of body wings 86, 88, protruding radially, along a median direction orthogonal to the diametric direction of said body brackets 82, 84 (FIG. 9a).

The side surface 78 further comprises a second body indentation 90, flanked by the body bracket 82, 84, and a first body indentation 92, flanked by the body wing 86, 88; said body indentations 90, 92 have different curvatures and intersect in a body edge 94 that divides them.

The two body indentations 90, 92 are repeated in the four gaps between the two body brackets 82, 84 and the two body wings 86, 88.

Moreover, the main body 76 comprises a pair of body shelves 94, 96, protruding radially from the respective body wing 86, 88, preferably beveled on the free edge, so as to create guides 94′, 96′ to snap into the undercut 98 formed below said body shelves 94, 96.

Preferably, each body shelf 94, 96 has a recess 101 for engagement with the respective element 200.

Furthermore, the main body 76 has a plurality of body passages 102 between a body bracket 82, 84 and the second body indentation 90 that flanks it, approximately at half the height of the main body 76.

The connection head 10 described above, lacking the elements 200, may be used with the second support 12b.

When the main body 76 is pushed axially into the second support 12b (FIGS. 7b, 2b and 3b), the elastic retainer 56 is stressed in such a way as to widen; in particular, the first sections 58 thereof, corresponding to the position of the body shelves 94, 96, widen and snap into the undercut 98, while the remaining sections run circumferentially to surround the side body surface 78, penetrating the body passages 102.

Once the main body 76 has been inserted into the second support 12b, the base recesses 54 are accommodated in the respective second body indentations 92 (FIG. 7b).

The elastic retainer 56, snap-engaging with the main body 76, therefore forms a connection that prevents the axial separation between the support 12b and the connection head 10; the accommodation of the bottom recesses 54 in the body indentations 92 forms instead an anti-rotation bond between the support 12b and the connection head 10.

The connection head 10 further comprises two elements 200, auxiliarily applicable to the main body 76 (FIG. 10).

Each element 200 comprises two main portions 202, arranged angularly spaced, joined together by a joining portion 204.

Each main portion 202 has an inner surface 206 counter-shaped to the first body indentation 92 and an outer surface 208 having an arched progression that connects to the surface of the second body indentation 90, thus forming an indentation 208′.

The joining portion 204 has a circumferential joining channel 209, which, when the auxiliary element 200 is applied to the main body 76, joins or forms an extension of said body passages 102.

Preferably, in addition, each main portion 202 has a guide 202′ to help it to snap into the joining channel 209; once the auxiliary element 200 is applied to the main body 76, said guides 202′ form a continuous guide surface with said guides 94′, 96′ of the body shelves 94, 96.

The connection head 10 further comprises connection means for the stable connection of the auxiliary element 200 to the main body 76.

For example, said connection means comprise a pair of pins 210, each protruding from the respective main portion 202, e.g. from the inner surface 206 thereof, and a pair of connection holes 212 made on the side surface 78 of the main body 76, e.g. at a first indentation 92.

Moreover, preferably, said connection means comprise the recess 101 obtained in the body shelf 94, 96 and a corresponding tail 214, e.g. in the shape of a swallow tail, protruding from the joining portion 204. The tail 214 is insertable into the recess 101 with shape-coupling.

Each element 200 is intended to be applied to the side surface 78 of the main body 76.

In particular, when the element 200 is applied to the main body 76, the joining portion 204 surrounds the body wing 86, 88; preferably, said joining portion 204 covers the undercut 98.

Each main portion 202, on the other hand, fills a respective first indentation 92, which flanks the body wing 86, 88 due to the part provided on the inner surface 206, and forms an extension of the second body indentation 90 due to the outer surface 208.

In particular, the height of the auxiliary element 200, i.e. the overall axial dimension, does not exceed the height of the main body, whereby the connection head 10, with or without auxiliary elements, maintains the same axial encumbrance.

The main body 76 is pushed axially into the first support 12a (FIGS. 7a, 2a and 3a), the elastic retainers 42, 44 are stressed in such a way as to widen; in particular, the sections 46, 48 inside the support 12a widen in contrast with the guide surface formed by the guides 202′ of the main portions 202 of the auxiliary element 200 and the guides 94′, 96′ of the body shelves 94, 96.

Said sections 46, 48 snap into the joining channel 209 and into the body passages 102.

Once the main body 76 has been inserted into the first support 12a, the support brackets 30, 32, 34, 36 are accommodated in the respective first body indentations 90 and, preferably, at least partially, in the respective indentations 208′ formed by the outer surfaces 208 of the main portion 202.

The elastic retainer 42, 44, snap-engaging with the main body 76, thus makes a connection that prevents the axial separation between the first support 12a and the connection head 10; the accommodation of the support brackets 30, 32, 34, 36 in the first body indentations 90 and preferably in the indentations 208′ forms instead an anti-rotation bond between the first support 12a and the connection head 10.

According to a variant embodiment, the auxiliary element 200 consisting of two main portions 202 and a joining portion 204, is replaced by a plurality of separate main portions, one for each body indentation 90, 92 to be filled.

According to a further variant embodiment, the connection head is provided with adjustment means for adjusting the rolling end stop. For example, said adjustment means comprise adjusting screws 216, accessible from the outside.

The connection head 10 further provides for a power supply conduit 300 suitable for the passage of a power cable C for the power supply to the motor.

The conduit 300 has an axial section 302 in the motor connection portion 70, and a radial section 304 in the support connection portion 72, open to the outside for the radial output of the power cable C.

The power supply conduit 300 further comprises another additional section 306, having an axial extension and arranged coaxially to the head 10, communicating with the axial section 302 and/or with the radial section 304.

Said additional section 306 allows the power cable C to emerge in a second, axial position.

According to a variant embodiment, the main body and the elements are made of plastic or metallic material, e.g. zamak. According to a further variant embodiment, the main body is made of metallic material, e.g. zamak, and the elements of plastic material.

It is apparent that one skilled in the art, in order to meet contingent needs, may make changes to the connection head described above, all contained within the scope of protection as defined by the following claims.

What is claimed is:

1. A connection head between an electric motor and a first fixed support or between said electric motor and a second fixed support of an apparatus for actuating roll-up awnings or blackout closures, said connection head comprising:
a main body, insertable axially into said second fixed support, wherein said main body comprises a side body surface, provided with a first body indentation to accommodate a support recess of the second fixed support and with a second body indentation flanked by said first body indentation, the first body indentation and the second body indentation being divided by a body edge; and
an element applicable auxiliarily to the side body surface of the main body, wherein said element comprises a main portion comprising an arched outer surface forming an indentation;
so that, when the element is applied to the main body, the indentation is connected to the second body indentation of the main body to accommodate at least one support bracket of the first fixed support.

2. The connection head of claim 1, wherein the main portion of the element comprises an inner surface counter-shaped with respect to the first body indentation and, when the element is applied to the main body, said main portion fills the first body indentation.

3. The connection head of claim 1, wherein the element has a height equal to or smaller than a height of the side body surface of the main body.

4. The connection head of claim 1, wherein the element comprises two main portions, spaced circumferentially, joined by a joining portion.

5. The connection head of claim 4, wherein said joining portion comprises a joining channel to accommodate a deformable section of an elastic retainer of the first fixed support.

6. The connection head of claim 1, wherein the main body further comprises a radial body wing, provided with a radially projecting body shelf, that forms an undercut with guides for snap engagement with a deformable section of an elastic retainer of the second fixed support.

7. The connection head according to of claim 4, wherein the main body further comprises a radial body wing, provided with a radially projecting body shelf, that forms an undercut with guides for snap engagement with a deformable section of an elastic retainer of the second fixed support and wherein the joining portion of the element is applied to the undercut.

8. The connection head of claim 7, wherein the joining portion comprises a tail and the body shelf comprises a recess, wherein the tail is insertable into the recess for applying the element to the main body.

9. The connection head according to of claim 1, wherein the main body and the element are made of plastic material or metallic material, including zamak.

10. The connection head of claim 1, further comprising a power supply conduit for passage of a power supply cable, wherein the power supply conduit comprises an axial section, a radial section open to the outside for radial output of the power supply cable and an additional section open to the outside for axial output of the power supply cable, having an axial extension and arranged coaxially at the head, communicating with the axial section.

11. The connection head of claim 1, wherein the main body is made of metallic material, including zamak, and the element is made of plastic material.

12. The connection head of claim 1, further comprising a power supply conduit for passage of a power supply cable, wherein the power supply conduit comprises an axial section, a radial section open to the outside for radial output of the power supply cable and an additional section open to the outside for axial output of the power supply cable, having an axial extension and arranged coaxially at the head, communicating with the radial section.
